(19) United States
(12) Patent Application Publication
(10) Pub. No.: US 2018/0119532 A1
(43) Pub. Date: May 3, 2018

(54) IMPROVED FRACTURE MATCHING FOR COMPLETION OPERATIONS

(71) Applicant: Halliburton Energy Services, Inc., Houston, TX (US)

(72) Inventors: Jianfu Ma, Pearland, TX (US); Avi Lin, Houston, TX (US)

(21) Appl. No.: 15/574,689

(22) PCT Filed: Jul. 8, 2015
(86) PCT No.: PCT/US2015/039518

§ 371 Date: Nov. 16, 2017

(51) Int. Cl. E21B 43/26; G01V 1/42; G01V 1/50

(52) U.S. Cl. CPC E21B 43/26; G01V 1/42; G01V 1/50; G01V 2210/646; G01V 2210/1425; G01V 2210/1429; G01V 2210/1234

(57) ABSTRACT

An example method may include receiving data corresponding to microseismic events within a subterranean formation generated by a stimulation operation and correlating at least two microseismic events based, at least in part, on the data corresponding to the at least two microseismic events. Characteristics of at least one fracture within the formation may be determined based, at least in part, on the correlation. A subsequent stimulation operation may be performed based, at least in part, on the determined characteristics.

### BACKGROUND

The present disclosure relates generally to well drilling and hydrocarbon recovery operations and, more particularly, to fracture matching in completion operations.

Hydrocarbons, such as oil and gas, are commonly obtained from subterranean formations that may be located onshore or offshore. The development of subterranean formations and the processes involved in removing hydrocarbons are complex. Typically, subterranean operations involve a number of different steps such as, for example, drilling a wellbore at a desired well site, treating the wellbore to optimize production of hydrocarbons, and performing the necessary steps to produce and process the hydrocarbons from the subterranean formation.

In certain instances, the development may include a hydraulic fracturing treatment in which highly pressurized fluids and proppants are pumped into a wellbore to induce and maintain artificial faults, cracks or fractures in the formation. These fractures may improve the productivity of the reservoir. When a fracture is induced, it may generate a seismic signal with a detectable energy level, referred to as a microseismic event. These events may be measured, collected, and used to model the network of induced fractures. Accurately modeling the fractures based on the microseismic events, however, can be challenging due to uncertainty in the fracturing treatments that caused the events, and the difficulty accounting for the occurrence of microseismic events over time.

### FIGURES

Some specific exemplary embodiments of the disclosure may be understood by referring, in part, to the following description and the accompanying drawings.

FIG. 1 is a diagram of an example well system, according to aspects of the present disclosure.

FIG. 2 is a diagram of the example computing system, according to aspects of the present disclosure.

FIG. 3 is a flow diagram illustrating an example process for determining a stage signature for a microseismic event, according to aspects of the present disclosure.

FIGS. 4a and 4b are diagrams illustrating a collection of microseismic events and their associated stage boundaries, according to aspects of the present disclosure.

FIGS. 5a and 5b are diagrams respectively illustrating a probability distribution of an example set of microseismic events and a corresponding correlation coefficient distribution, according to aspects of the present disclosure.

FIG. 6 is a diagram illustrating another probability distribution of an example set of microseismic events, according to aspects of the present disclosure.

FIG. 7 is a diagram illustrating a probability distribution for an example set of determined potential fracture planes plotted in azimuth-dip space, according to aspects of the present disclosure.

FIG. 8 is a diagram illustrating an example flow chart for identifying hydraulic fracture planes, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions are made to achieve the specific implementation goals, which will vary from one implementation to another. Moreover, it will be appreciated that such a development effort might be complex and time-consuming, but would, nevertheless, be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like. “Measurement-while-drilling” (“MWD”) is the term generally used for measuring conditions downhole concerning the movement and location of the drilling assembly while the drilling continues. “Logging-while-drilling” (“LWD”) is the term generally used for similar techniques that concentrate more on formation parameter measurement. Devices and methods in accordance with certain embodiments may be used in one or more of wireline (including wireline, slickline, and coiled tubing), downhole robot, MWD, and LWD operations.

For purposes of this disclosure, an information handling system may comprise a computing system and may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processor or processing resource such as a central processing unit (CPU) or hardware or software control logic, ROM, and/or other types of nonvolatile memory. As used herein, a processor may comprise a microprocessor, a microcontroller, a digital signal processor (DSP), an application specific integrated circuit (ASIC), or any other digital or analog circuitry configured to interpret and/or execute program instructions and/or process data for the associated tool or sensor. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

The terms “couple” or “couples” as used herein are intended to mean either an indirect or a direct connection. Thus, if a first device couples to a second device, that connection may be through a direct connection, or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections. Finally, the term “fluidically coupled” as used herein is intended to mean that there is either a direct or an indirect fluid flow path between two components.

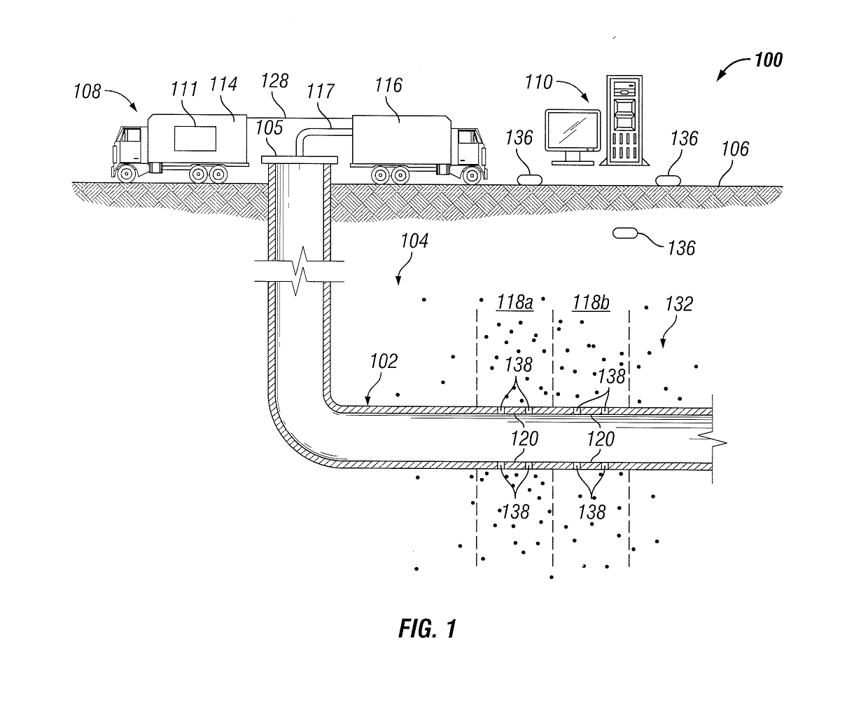

FIG. 1 is a diagram of an example well system 100. The example well system 100 includes a wellbore 102 in a subterranean region 104 beneath the ground surface 106. The example wellbore 102 shown in FIG. 1 includes a horizontal wellbore. However, a well system may include any combination of horizontal, vertical, slant, curved, or other wellbore orientations. In certain embodiments, a horizontal well may be substantially parallel with the principal stress of the subterranean region 104 to provide maximum fracture extension during certain stimulation operations. The well system 100 can include one or more additional treatment wells, observation wells, or other types of wells.

The well system 100 further includes a computing system 110 with one or more computing devices or systems located at or near the wellbore 102, or away from the wellbore 102. The computing system 110 or any of its components can be located apart from the other components shown in FIG. 1. For example, the computing system 110 can be located at a data processing center, a computing facility, or another suitable location. The well system 100 can include additional or different features, and the features of the well system can be arranged as shown in FIG. 1 or in another configuration.

The example subterranean region 104 may include a reservoir that contains hydrocarbon resources, such as oil, natural gas, or others. For example, the subterranean region 104 may include all or part of a rock formation (e.g., shale, coal, sandstone, granite, or others) that contain natural gas. The subterranean region 104 may include naturally fractured rock or natural rock formations that are not fractured to any significant degree. The subterranean region 104 may include tight gas formations of low permeability rock (e.g., shale, coal, or others).

As depicted, the example well system 100 includes an injection system 108. The injection system 108 can be used to perform a stimulation treatment that includes, for example, an injection treatment and a flow back treatment. During an injection treatment, fluid is injected into the subterranean region 104 through the wellbore 102. In some instances, the injection treatment fractures part of a rock formation or other materials in the subterranean region 104. In such examples, fracturing the rock may increase the surface area of the formation, which may increase the rate at which the formation conducts fluid resources to the wellbore 102.

A fracture treatment can be applied at a single fluid injection location or at multiple fluid injection locations in a subterranean region, and the fluid may be injected over a single time period or over multiple different time periods. In some instances, a fracture treatment can use multiple different fluid injection locations in a single wellbore, multiple fluid injection locations in multiple different wellbores, or any suitable combination. Moreover, the fracture treatment can inject fluid through any suitable type of wellbore, such as, for example, vertical wellbores, slant wellbores, horizontal wellbores, curved wellbores, or any suitable combination of these and others.

The injection system 108 can inject treatment fluid into the subterranean region 104 from the wellbore 102. The injection system 108 includes instrument trucks 114, pump trucks 116, and an injection control system 111. The injection system 108 may include other features not shown in the figures. The injection system 108 may apply injection treatments that include, for example, a single-stage injection treatment, a multi-stage injection treatment, a mini-fracture test treatment, a follow-on fracture treatment, a re-fracture treatment, a final fracture treatment, other types of fracture treatments, or a combination of these.

As depicted, the injection system 108 uses multiple treatment stages or intervals 118a and 118b (collectively “stages 118”). The injection system 108 may delineate fewer stages or multiple additional stages beyond the two example stages 118 shown. The stages 118 may each have one or more perforation clusters 120. A perforation cluster can include one or more perforations 138 within a downhole casing, for instance. Fractures in the subterranean region 104 can be initiated at or near the perforation clusters 120 or elsewhere. The stages 118 may have different widths, or the stages 118 may be uniformly distributed along the wellbore 102. The stages 118 can be distinct, non-overlapping (or overlapping) injection zones along the wellbore 102. In some instances, each of the multiple treatment stages 118 can be isolated, for example, by packers or other types of seals in the wellbore 102. In some instances, each of the stages 118 can be treated individually, for example, in series along the extent of the wellbore 102. The injection system 108 can perform identical, similar, or different injection treatments at different stages.

The pump trucks 116 can include mobile vehicles, immobile installations, skids, hoses, tubes, fluid tanks, fluid reservoirs, pumps, valves, mixers, or other types of structures and equipment. The pump trucks 116 can supply treatment fluid or other materials for the injection treatment. The pump trucks 116 may contain multiple different treatment fluids, proppant materials, or other materials for different stages of a stimulation treatment. The pump trucks 116 can communicate treatment fluids into the wellbore 102, for example, through a conduit, at or near the level of the ground surface 106. The treatment fluids can be communicated through the wellbore 102 from the ground surface 106 level by a conduit installed in the wellbore 102. The conduit may include casing cemented to the wall of the wellbore 102. In some implementations, all or a portion of the wellbore 102 may be left open, without casing. The conduit may include a working string, coiled tubing, sectioned pipe, or other types of conduit.

The instrument trucks 114 can include mobile vehicles, immobile installations, or other suitable structures. The example instrument trucks 114 include an injection control system 111 that controls or monitors the stimulation treatment applied by the injection system 108. The communication links 128 may allow the instrument trucks 114 to communicate with the pump trucks 116, or other equipment at the ground surface 106. Additional communication links may allow the instrument trucks 114 to communicate with sensors or data collection apparatus in the well system 100, remote systems, other well systems, equipment installed in the wellbore 102 or other devices and equipment.

As depicted, the injection control system 111 controls operation of the injection system 108. The injection control system 111 may include data processing equipment, communication equipment, or other systems that control stimulation treatments applied to the subterranean region 104 through the wellbore 102. The injection control system 111 may include or be communicably linked to a computing system (e.g., the computing system 110) that can calculate, select, or optimize fracture treatment parameters for initialization, propagation, or opening fractures in the subterranean region 104. The injection treatment control system 111 may receive, generate or modify a stimulation treatment plan (e.g., a pumping schedule) that specifies properties of a stimulation treatment to be applied to the subterranean region 104.

The stimulation treatment, as well as other activities and natural phenomena, can generate microseismic events in the subterranean region 104. These microseismic events may comprise acoustic signals that are generated by rock slips, rock movements, rock fractures or other events in the subterranean region 104. Microseismic events in the subterranean region 104 may occur, for example, along or near induced hydraulic fractures. The microseismic events may be associated with pre-existing natural fractures or hydraulic fracture planes induced by fracturing activities. Hydraulic fracture planes induced by fracturing activities may cause microseismic events due to acoustic energy being released from shear stresses gradients, as well as from compression effects and changes in the stresses principal directions caused by the fracture fluids. For example, microseismic events may be generated in the vicinity of tips of the induced fractures where high shear stresses are generated, and at large curvatures in the fractures due to relatively sharp compression changes.

As depicted, the injection system 108 has caused multiple microseismic events 132 during a multi-stage injection treatment. The acoustic signals corresponding to these events 132 may be received and recorded. These received acoustic signals may comprise and/or may be processed to produce microseismic event data corresponding to the microseismic event that generated the acoustic signal. For instance, microseismic event data for a given microseismic event may comprise a time stamp corresponding to the microseismic event (e.g., when the event occurred, or when it was received and/or recorded); a location of the microseismic event, such as two- or three-dimensional coordinates for the event; and an initial energy level for the event. As depicted, the injection system 108 comprises one or more sensors 136 that receive the acoustic signals, but the signals may be collected by other types of systems. As described above, the microseismic information detected in the well system 100 can include acoustic signals generated by natural phenomena, acoustic signals associated with a stimulation treatment applied through the wellbore 102, or other types of signals.

The system 100 may include sensors 136, including a microseismic array and other equipment that can be used to detect microseismic signals. The sensors 136 may include geophones or other types of listening equipment. The sensors 136 can be located at a variety of positions in the well system 100, such as at the surface 106 and beneath the surface 106 in an observation well (not shown). Additionally or alternatively, sensors may be positioned in other locations above or below the surface 106, in other locations within the wellbore 102, or within another wellbore (e.g., another treatment well or an observation well).

All or part of the computing system 110 can be contained in a technical command center at the well site, in a real-time operations center at a remote location, in another appropriate location, or any suitable combination of these. The well system 100 and the computing system 110 can include or access any suitable communication infrastructure. For example, well system 100 can include multiple separate communication links or a network of interconnected communication links. The communication links can include wired or wireless communications systems. For example, the sensors 136 may communicate with the instrument trucks 114 or the computing subsystem 110 through wired or wireless links or networks, or the instrument trucks 114 may communicate with the computing subsystem 110 through wired or wireless links or networks. The communication links can include a public data network, a private data network, satellite links, dedicated communication channels, telecommunication links, or any suitable combination of these and other communication links.

The computing system 110 can analyze microseismic signals and data collected in the well system 100. For example, the computing subsystem 110 may analyze microseismic event data from a stimulation treatment of a subterranean region 104. Microseismic data from a stimulation treatment can include data collected before, during, or after fluid injection. The computing system 110 can receive the microseismic data at any suitable time. In some instances, the computing subsystem 110 receives the microseismic data in real time (or substantially in real time) during the fracture treatment. For example, the microseismic data may be sent to the computing system 110 immediately upon detection by the sensors 136. In some instances, the computing system 110 receives some or all of the microseismic data after the fracture treatment has been completed. The computing system 110 can receive the microseismic data in any suitable format. For example, the computing system 110 can receive the microseismic data in a format produced by microseismic sensors or detectors, or the computing system 110 can receive the microseismic data after the microseismic data has been formatted, packaged, or otherwise processed. The computing system 110 can receive the microseismic data, for example, by a wired or wireless communication link, by a wired or wireless network, or by one or more disks or other tangible media.

The computing system 110 can perform, for example, fracture mapping and matching based on collected microseismic event data to identify fracture orientation trends and extract fracture network characteristics. The characteristics may include fracture orientation (e.g., azimuth and dip angle), fracture size (e.g., length, height, surface area), fracture spacing, fracture complexity, stimulated reservoir volume (SRV), or another property.

In one example operation, the injection system 108 can perform an injection treatment, for example, by injecting fluid into the subterranean region 104 through the wellbore 102. The injection treatment can be, for example, a multi-stage injection treatment where an individual injection treatment is performed during each stage. The injection treatment can induce microseismic events in the subterranean region 104. Sensors (e.g., the sensors 136) or other detecting equipment in the well system 100 can detect the microseismic events, and collect and transmit the microseismic event data, for example, to the computing system 110. The computing system 110 can receive and analyze the microseismic event data. For instance, the computing subsystem 110 may associate the microseismic events with one or more of the stages 118, as well as perform temporal and spatial correlations with respect to the events 132 that may help to improve the accuracy and the physical correctness of the determined fracture characteristics. The determined characteristics can be presented to well operators, field engineers, or others to visualize and analyze the temporal and spatial evolution of the fractures. In some implementations, the microseismic event data can be collected, communicated, and analyzed in real time during an injection treatment. In some implementations, the computed fracture characteristics can be provided to the injection control system 111. A current or a prospective treatment strategy can be adjusted or otherwise managed based on the computed fracture characteristics, for example, to improve the efficiency of the injection treatment.

Some of the techniques and operations described here may be implemented by a computing system configured to provide the functionality described. In various embodiments, a computing system may include any of various types of devices, including, but not limited to, personal computer systems, desktop computers, laptops, notebooks, mainframe computer systems, handheld computers, workstations, tablets, application servers, storage devices, computing clusters, or any type of computing or electronic device.

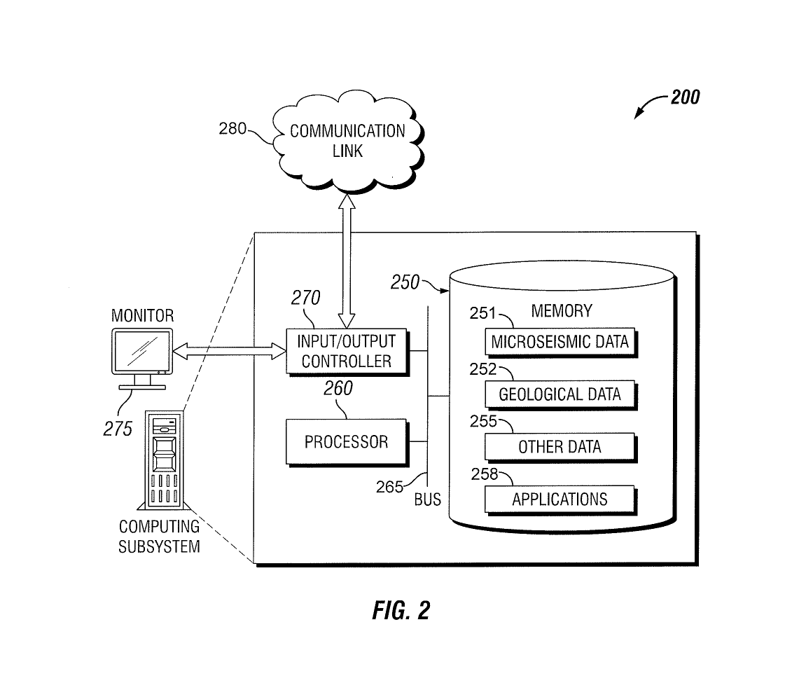

FIG. 2 is a diagram of the example computing system. The example computing system 200 can be located at or near one or more wells of a well system or at a remote location. All or part of the computing system 200 may operate independent of a well system or independent of any of the other components. The example computing system 200 includes a memory 250, a processor 260, and input/output controllers 270 communicably coupled by a bus 265. The memory 250 can include, for example, a random access memory (RAM), a storage device (e.g., a writable read-only memory (ROM) or others), a hard disk, or another type of storage medium. The computing system 200 can be preprogrammed or it can be programmed (and reprogrammed) by loading a program from another source (e.g., from a CD-ROM, from another computer device through a data network, or in another manner). In some examples, the input/output controller 270 is coupled to input/output devices (e.g., a monitor 275, a mouse, a keyboard, or other input/output devices) and to a communication link 280. The input/output devices receive and transmit data in analog or digital form over communication links such as a serial link, a wireless link (e.g., infrared, radio frequency, or others), a parallel link, or another type of link.

The communication link 280 can include any type of communication channel, connector, data communication network, or other link. For example, the communication link 280 can include a wireless or a wired network, a Local Area Network (LAN), a Wide Area Network (WAN), a private network, a public network (such as the Internet), a WiFi network, a network that includes a satellite link, or another type of data communication network.

The memory 250 can store instructions (e.g., computer code) associated with an operating system, computer applications, and other resources. The memory 250 can also store application data and data objects that can be interpreted by one or more applications or virtual machines running on the computing system 200. The example memory 250 includes microseismic data 251, geological data 252, other data 255, and applications 258. In some implementations, a memory of a computing device includes additional or different data, applications, models, or other information.

The microseismic data 251 can include information on microseismic events in a subterranean area. For example, the microseismic data 251 can include information based on acoustic data detected at the wellbore, at the surface, at other locations, or at some combination of the preceding locations. The microseismic data 251 can include information collected by sensors 236. In some cases, the microseismic data 251 includes information that has been combined with other data, reformatted, or otherwise processed. The microseismic event data may include any suitable information relating to microseismic events (e.g., locations/coordinates, times, magnitudes, moments, uncertainties, etc.). In certain embodiments, the microseismic event data may further include stage signature identifiers that associate a given microseismic event with one or more fracture stages, as will be described below, as well as temporal and spatial correlation algorithms that will also be described below. The microseismic event data can include data collected from one or more stimulation treatments, which may include data collected before, during, or after a fluid injection.

The geological data 252 can include information on the geological properties of the subterranean zone being stimulated. For example, the geological data 252 may include information on the wellbore 202, or information on other attributes of the subterranean region 204. In some cases, the geological data 252 includes information on the lithology, fluid content, stress profile, pressure profile, spatial extent, or other attributes of one or more rock formations in the subterranean area. The geological data 252 can include information collected from well logs, rock samples, outcroppings, microseismic imaging, or other data sources.

The applications 258 can include software applications, scripts, programs, functions, executables, or other modules that are interpreted or executed by the processor 260. The applications 258 may include machine-readable instructions for performing one or more of the operations described below. The applications 258 can obtain input data, such as treatment data, geological data, microseismic data, or other types of input data, from the memory 250, from another local source, or from one or more remote sources (e.g., via the communication link 280). The applications 258 can generate output data and store the output data in the memory 250, in another local medium, or in one or more remote devices (e.g., by sending the output data via the communication link 280).

The processor 260 can execute instructions, for example, to generate output data based on data inputs. For example, the processor 260 can run the applications 258 by executing or interpreting the software, scripts, programs, functions, executables, or other modules contained in the applications 258. The processor 260 may perform one or more of the operations described below. The input data received by the processor 260 or the output data generated by the processor 120 can include any of the microseismic data 251, the geological data 252, or the other data 255.

According to aspects of the present disclosure, one or more applications may use the geo-mechanics of microseismic events to identify fracture characteristics based on microseism clusters or groups of microseism clusters with some degree of dispersion. This application may include, for example, an identification of a stage signature for each microseismic event, as well as temporal and spatial correlations between microseismic events that may help to improve the accuracy and the physical correctness of subsequent fracture mapping. The application may further include a determination of a confidence value associated with the identified fractures. In certain embodiments, the application may exhibit real-time dynamics of hydraulic fractures to field engineers and operators, to assist them in analyzing the fracture complexity and reservoir geometry, and to help them better understand the hydraulic fracturing process. In certain embodiments, the functionalities described above may be separated into different applications that individually or collectively operate to produce the described results.

As described above, the completion stages may be overlapping or non-overlapping. When the completion stages are overlapping (e.g., when fractures from one fracture stage grow into previous fractured zone) the two treatment stages interact with each other such that some of the hydraulic fractures may be connected to those generated in the previous hydraulic fracturing processes. Given the overlap, and the fact that fractures can change over time, it can be difficult to determine the source of a particular microseismic event. Typically, the events in overlapping zones are excluded from subsequent calculations or are otherwise processed separately. This can reduce the accuracy of the fracture characteristic determination for the fracture stages by failing to account for the full extent of the fractures and the potential loss of treatment fluid and a reduction in the stimulation effectiveness through the overlapping fractures.

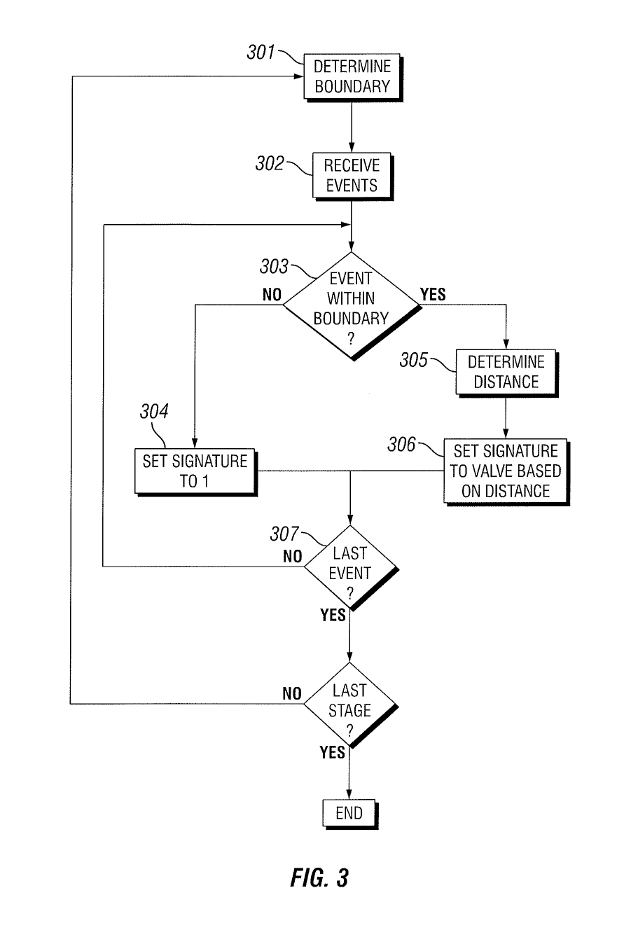

Accordingly to aspects of the present disclosure, an example application may assign a stage signature to the microseismic events measured by the sensors of the completion system. A stage signature for a microseismic event may comprise a probability that the event was caused by a particular stimulation stage. FIG. 3 is a flow diagram illustrating an example process for determining a stage signature for a microseismic event, according to aspects of the present disclosure. At step 301, a boundary for a first stimulation stage may be determined. This may include receiving location data for a group of microseismic events measured during a first stimulation stage and determining a two-dimensional boundary containing an area or a three-dimensional boundary containing a volume that includes some or all of the group of microseismic events. In certain embodiments, the location data for each event may comprise rectangular coordinates that identify the location of the microseismic event within the formation. The location data for the group of microseismic events may be received, for example, at a computing system or processor from the sensors in the field, from a storage medium within the computing system, or from a storage medium remote from the computing system, such as a data repository.

In certain embodiments, determining the two- or three-dimensional boundary may comprise using a convex hull or convex envelope algorithm to determine the smallest convex set containing the group of microseismic events, as would be appreciated by one of ordinary skill in the art in view of this disclosure. Like the location data, the boundary may be characterized by rectangular coordinates, or equations within a rectangular coordinate space. The group of microseismic events may comprise microseismic events that occur from a time period beginning immediately after the first stimulation stage is begun and ending when the first completion stage ends or at some time thereafter, and may be selected based, at least in part, on the time signature associated with each event. In certain embodiments, the group of microseismic events may further be limited to events occurring within the proximity of the first stimulation stage.

Step 302 comprises receiving location data for a group of microseismic events measured during a second stimulation stage. Like the location data for the group of events measured during the first stimulation stage, the location data for the group of events measured during the second stimulation stage may be received, for example, at a computing system or processor from the sensors in the field, from a storage medium within the computing system, or from a storage medium remote from the computing system, such as a data repository. In certain embodiments, the microseismic events received during the second stimulation stage may comprise microseismic events that occur from a time period beginning immediately after the second stimulations stage is begun and ending when the second completion stage ends or at some time thereafter, and may be selected based, at least in part, on the time signature associated with each event. In certain embodiments, the group of microseismic events may further be limited to events occurring within the proximity of the second stimulation stage.

Step 303 comprises determining whether an event of the group of events measured during the second stimulation stage is within the determined boundary. As described above, each event may be associated with rectangular coordinates that identify the location of the microseismic event within the formation. Similarly, the determined boundary may be defined, in part, by one or more planes within the rectangular coordinates, with those planes forming a bounded volume or area. Determining whether an event of the group of events measured during the second stimulation stage is within the determined boundary may comprise comparing the rectangular coordinates of that event with the coordinates of the bounded volume within the determined boundaries.

At step 304, if the microseismic event is not within the determined boundary for the first stimulation stage, a stage signature associated with that microseismic event may be set to a first value. As depicted, that value is 1, which represents a 100% probability that the microseismic event belongs to the second stimulation stage, rather than the first stage. Other values are possible within the scope of this disclosure. In certain embodiments, setting the stage signature associated with the microseismic event may include modifying a data set associated with the microseismic event in a storage device to include the first value, although other values and identifiers are possible.

At step 305, if a received microseismic event is within the determined boundary for the first stimulation stage, a distance of the microseismic event from the boundary may be determined, and, at step 306, the stage signature associated with that microseismic event may be set to a second value less that the first value, indicating a less that 100% probability that the received microseismic event belongs to the second stage. In certain embodiments, the stage signature value may be based, at least in part, on the determined distance. Specifically, the closer the received microseismic event is to the boundary, the more likely it is to be associated with the second stimulation stage. The probability that a received microseismic event at a given distance from a boundary of a previous stimulation stage was caused by a subsequent stimulation stage, and therefore the value assigned to the stage signature, may be based, for example, on experimental values, or linear or non-linear correspondence with the distance.

At step 307, after the microseismic event's stage signature has been set, it may be determined whether that microseismic event is the last entry in the group of events measured during the second stimulation stage. If it is not, the next microseismic event may be selected, and the steps 303-307 completed with respect to that microseismic event. If the microseismic event is the last entry in the group of events measured during the second stimulation stage, then it may be determined at step 308 whether the second stimulation stage is the last stimulation stage. If it is not, the process may begin with a boundary for the second stimulation stage being determined, and a group of microseismic events measured during a third stimulation stage being compared with the boundary for the second stimulation stage. The process may continue until all of the microseismic events and stages are processed. In other embodiments, the application may determine an event's stage signature in real time as the events are collected or acquired by the sensors. For instance, before beginning a second stimulation stage, the boundary of the first stimulation stage may be calculated, and each event's stage signature determined by a comparison with that boundary as the event is received. This may facilitate real-time fracture mapping.

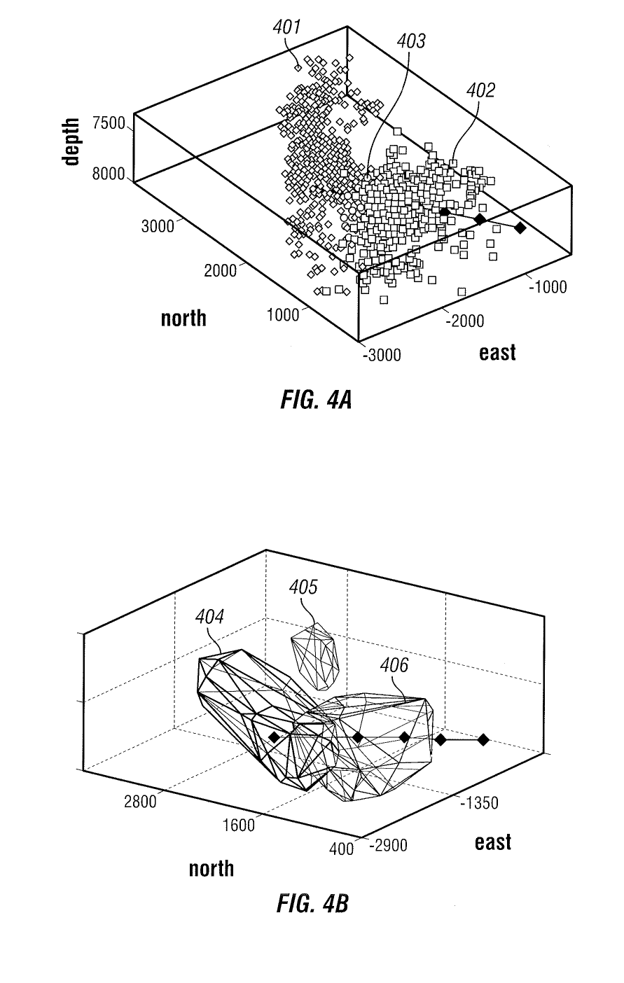

FIGS. 4a and 4b are diagram illustrating a collection of microseismic events and their associated stage boundaries, according to aspects of the present disclosure. As depicted, FIG. 4a illustrates a group of microseismic events 401 measured during a first stimulation stage, and a group of microseismic events 402 measured during a second stimulation stage. The group 402 includes events 403 that are near to or otherwise overlapping the group of microseismic events 401. FIG. 4b illustrates fractured reservoir volumes 404 and 405 corresponding to the groups 401 and 402, with the volumes 404 and 405 being defined by complex convex hull boundaries, similar to the ones described above. The volumes 404 and 405 overlap at a volume 406, which has been extracted from the reservoir volumes 404 and 405 for illustrative purposes. Events 402 falling outside of the volumes 404 and 406 may be assigned a stage signature of 1, indicating there is a 100% probability those events were generated by the second stimulation stages. Events 403, falling within the volume 406, may be assigned a stage signature less than 1 based, at least in part, on the distance to the boundary of the volume 406.

In addition to determining an event's stage signature, one or more applications may determine temporal and/or spatial correlations between the microseismic events. When a stimulation stage is undertaken, and stimulation fluids are injected into the formation, the stimulation fluids may cause cracks or fractures within the formation. These cracks or fractures are generally aligned in planes that may depend, in part, on the characteristics of the formation. The orientation of the planes and the number of fracture planes may be important to determining the success of the stimulation stage. The orientation and number of fracture planes, however, may change during the stimulation stage. For instance, the orientation of the primary fracture plane may change over time, or new primary fracture planes may develop, such that post-stage data processing does not accurately model and identify all of the fracture planes developed by the stimulation stage. As will be described below, temporal and/or spatial correlations may be used with the stage signatures to improve the determination of fracture planes and individual fractures in both real-time and post-data calculations.

During a stimulation stage, microseismic events may be received at one or more sensors over time as a stream of microseismic data. These microseismic events may be associated with the times at which they are received. For instance, a series of n acquired microseismic events may be represented by the series {t₁, t₂, . . . , tₙ}, with each entry identifying the time at which the corresponding microseismic event was acquired. The temporal correlation may be considered a statistical process over {Δt₁, Δt₂, . . . , Δtₙ}, with Δtᵢ denoting the time difference between two successive microseismic events Δtᵢ=tᵢ₊₁₋tᵢ. The statistical process may identify, for instance, the probability that two microseismic events belong to the same fracture or fracture plane depending on the time difference between those two events.

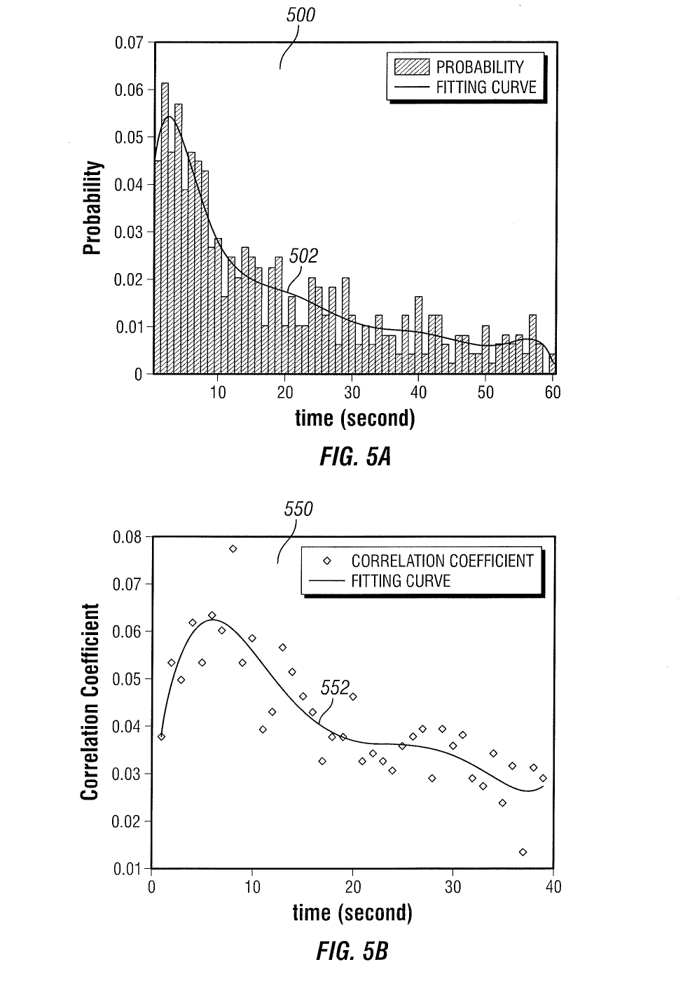

FIGS. 5a and 5b are diagrams respectively illustrating a probability distribution 500 of this statistical process Δt over an example set of microseismic events acquired during a single stimulation stage, and a corresponding correlation coefficient distribution 550. The probability distribution 500 plots the probability that two microseismic events belong to the same fracture verses the time between those two events in second increments, as well as a curve 502 fitted to the probability values that illustrates the statistical properties of the distribution 500. The curve 502 may be generated, for instance, using one or more fitting algorithms that would be appreciated by one of ordinary skill in the art in view of this disclosure.

The correlation coefficient distribution 550 identifies correlation coefficients between subsequent microseismic events calculated with equation (1), with the mean and standard deviation of the statistical process used to generate the probability distribution respectively denoted as μ and σ.

$$R ( τ ) = \frac{1}{{σ}^{2}} \frac{1}{( n - τ )} {\sum }_{i = 1}^{n - τ} ( Δ {t}_{i} - μ ) ( Δ {t}_{i + τ} - μ ) \\ μ = \frac{1}{n - 1} {\sum }_{i = 1}^{n - 1} Δ {t}_{i} , σ = \sqrt{\frac{1}{n - 1} {\sum }_{i = 1}^{n - 1} {( Δ {t}_{i} - μ )}^{2}} \qquad ( 1 )$$

The correlation coefficient distribution 550 also includes a curve 552 fitted to the plotted values, in this case correlation coefficients.

As depicted, the curves 502 and 552 illustrate similar characteristics with respect to the temporal correlation of the microseismic events. Specifically, the curves 502 and 552 increase over short durations before reaching a maximum value, at which point they start to decrease before reaching asymptotic values. This implies, generally, that microseismic events occurring close in time are more likely to correlate to a single fracture or fracture plane than events occurring at greater time intervals.

The temporal correlation information may be accounted for in subsequent data calculations, as will be described below, by determining and performing the subsequent data calculations using a temporal correlation weight between two microseismic events that is based, at least in part, on the time duration between the occurrence of those events. In certain embodiments, a piecewise continuous function may be used to assign the weights to the events as a function of time. The piecewise continuous function may be useful to the extent it can generally represent the shape of the curves 502 and 502, with a maximum weight being given to microseismic events occurring before or until the maximum correlation point is reached, a minimum weight being given to microseismic events occurring after asymptotic conditions are reached, and some portion of the weight being assigned to microseismic events occurring between the maximum correlation point and the asymptotic condition. One example piece wise continuous function is shown below in equation (2).

$${w}_{t} ( t ) = \{ \begin{matrix}{w}_{max \_ t} & if t < {t}_{1} \\ f ( t ) & if t ∈ [ {t}_{1} , {t}_{2} ] \\ {w}_{min \_ t} & if t > {t}_{2}\end{matrix} \qquad ( 2 )$$

In equation (2) wₜ(t) corresponds to the weight assigned to two microseismic events that occurred at a time difference t, wₘₐₓ_{_}ₜ corresponds to a maximum weight for the microseismic event temporal correlation (e.g., 1), wₘᵢₙ_{_}ₜ corresponds to a minimum weight for the microseismic event temporal correlation (e.g., 0), t₁ corresponds to the approximate time between two microseismic events at which the correlation maximum occurs, and t₂ corresponds to the approximate time between two microseismic events at which the asymptotic condition occurs, and f(t) corresponds to a function with which to assign an intermediate weight between the maximum and minimum to microseismic events that occurred at a time difference between time t₁ and time t₂. One example function f(t) comprises a linear function, such as

$$f ( t ) = {w}_{max \_ t} - \frac{t - {t}_{1}}{{t}_{2} - {t}_{2}} ( {w}_{max \_ t} - {w}_{min \_ t} ) .$$

Another example function f(t) comprises an exponential function, such as

$$f ( t ) = {w}_{max \_ t} {e}^{- α \frac{t - {t}_{1}}{{t}_{2} - {t}_{1}}} , α = ln \frac{{w}_{max \_ t}}{{w}_{min \_ t}} .$$

Other functions for assigning weights according to temporal correlation are possible within the scope of this disclosure.

In addition to the temporal correlation, microseismic events may have similarly correlated spatial parameters. As described above, microseismic events may be identified by coordinates, such as rectangular coordinates, in the formation. These spatial coordinates may be used with trigonometric calculations, for instance, to determine a distance d between the microseismic events. The probability that two microseismic events belong to the same fracture or fracture plane may be a function of this distance.

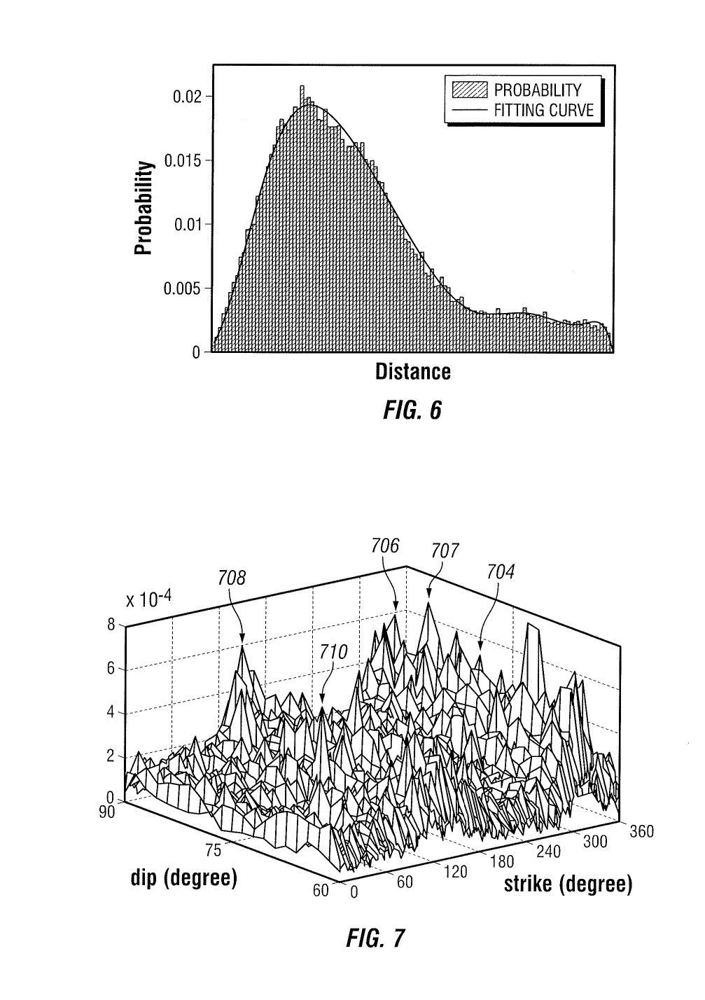

FIG. 6 is a diagram illustrating an example probability distribution 600 with respect to the distance d between the microseismic events. As depicted, the distribution 600 comprises a similar shape as the temporal correlation distributions, increasing until a maximum correlation is reached, then decreasing until an asymptotic condition is reached. Like the temporal correlations, the spatial correlation between two microseismic events may be represented as a weighted value. Also like the temporal correlation, a piecewise continuous function may be used to determine those weights. One example piece wise continuous function is shown below in equation (3).

$${w}_{s} ( d ) = \{ \begin{matrix}{w}_{max \_ s} & if d < {d}_{1} \\ g ( d ) & if d ∈ [ {d}_{1} , {d}_{2} ] \\ {w}_{min \_ s} & if d > {d}_{2}\end{matrix} \qquad ( 3 )$$

In equation (3) wₛ(d) corresponds to the weight assigned to two microseismic events separated by a distance d, wₘₐₓ_{_}ₛ corresponds to a maximum weight for the microseismic event spatial correlation (e.g., 1), wₘᵢₙ_{_}ₛ corresponds to a minimum weight for the microseismic event spatial correlation (e.g., 0), d₁ corresponds to the approximate distance between microseismic events at which the spatial correlation maximum occurs, and d₂ corresponds to the approximate distance between microseismic events at which the asymptotic condition occurs, and g(d) corresponds to a function with which to assign an intermediate weight between the maximum and minimum to microseismic events separated by a distance between distance d₁ and distance d₂. One example function g(d) comprises a linear function, such as

$$f ( t ) = {w}_{max \_ t} - \frac{t - {t}_{1}}{{t}_{2} - {t}_{2}} ( {w}_{max \_ t} - {w}_{min \_ t} ) .$$

Another example function g(d) comprises an exponential function, such as

$$f ( t ) = {w}_{max \_ t} {e}^{- α \frac{t - {t}_{1}}{{t}_{2} - {t}_{1}}} , α = ln \frac{{w}_{max \_ t}}{{w}_{min \_ t}} .$$

Other functions for assigning weights according to spatial correlation are possible within the scope of this disclosure

The spatial and temporal correlation weights as well as the stage signature associated with each acquired microseismic event may be used, for instance, to construct a probability distribution of fracture orientations within the formation. This probability distribution may be used to identify potential dominant fracture orientations, and those potential dominant fracture orientations may be used to identify individual fractures and/or to quantify a fracture confidence level. The probability distribution of fracture orientations within the formation may be constructed to identify multiple fracture orientation trends embedded in a set of microseismic events.

Constructing the probability distribution of fracture orientations may include, for instance, constructing planes from each combination of three microseismic events within a set of microseismic events and assigning weights to each plane. These weights can then be plotted to identify peaks that indicate fracture orientations directions where there are potentially, high stage signatures and higher temporal and spatial correlations among the microseismic events. These peaks may define possible dominant fracture orientations.

A potential fracture plane may be determined, for instance, using three non-collinear microseismic events characterized by rectangular coordinates (e.g., E₁ (xᵢ, y₁, z₁), E₂ (x₂, y₂, z₂), and E₃ (x₃, y₃, z₃)) using the following equation:

$$ax + by + c + d - 0$$

$$where$$

$$a - \vert \begin{matrix}1 & {y}_{1} & {z}_{1} \\ 1 & {y}_{2} & {z}_{2} \\ 1 & {y}_{3} & {z}_{3}\end{matrix} \vert , b - \vert \begin{matrix}{x}_{1} & 1 & {z}_{1} \\ {x}_{2} & 1 & {z}_{2} \\ {x}_{3} & 2 & {z}_{3}\end{matrix} \vert , c - \vert \begin{matrix}{x}_{1} & {y}_{1} & 1 \\ {x}_{2} & {y}_{2} & 1 \\ {x}_{3} & {y}_{3} & 1\end{matrix} \vert , d = - \vert \begin{matrix}{x}_{1} & {y}_{1} & {z}_{1} \\ {x}_{2} & {y}_{2} & {z}_{2} \\ {x}_{3} & {y}_{3} & {z}_{3}\end{matrix} \vert$$

The above equation, however, is offered by way of example and other expressions may to lead to the same results. The determined fracture plane may be characterized by an azimuth φ and the dip angle θ with respect to the borehole that may be calculated by the following equation:

$$ϕ = arctan \frac{b}{a} , θ = arctan \frac{\sqrt{{a}^{2} + {b}^{2}}}{c}$$

The principal values of the arctan functions may be taken and then transformed to the interval between 0 and 360 degree.

In addition to characterizing the potential fracture plane in space, the potential fracture plane may be assigned a statistical or probabilistic weight. That weight may be determined based, at least in part, on the stage signatures of the events and the temporal and spatial correlation between the events. For instance, determining the weight of the plane may first include determining a weight associated with each combination of two microseismic events (e.g., E₁ and E₂, E₁ and E₃, and E₂ and E₃) from the set of three microseismic events that define the determined potential fracture plane. In certain embodiments, the weight w_{i,j} associated with a combination of any two microseismic events (i, j) may be defined, at least in part, by the following equation:

$${w}_{i , j} = \frac{{S}_{i} + {S}_{j}}{2} \times {w}_{t}^{i , j} \times {w}_{s}^{i , j}$$

wherein Si and Sj correspond respectively to the event stage signatures for the ith and jth microseismic events, wₜ^{i,j} corresponds to the temporal correlation weight between the ith and jth microseismic events, and wₛ^{i,j} corresponds to the temporal correlation weight between the ith and jth microseismic events. For example, the weight associated with events E₁ and E₂ may comprise

$${w}_{1 , 2} = \frac{{S}_{1} + {S}_{2}}{2} \times {w}_{t}^{1 , 2} \times {w}_{s}^{1 , 2}$$

Once the weights associated with all three combinations of events are determined, the weight of the potential plane may be determined, for instance, by averaging the weights associated with all three combinations using the following equation

$$w = \frac{{w}_{1 , 2} + {w}_{1 , 3} + {w}_{2 , 3}}{3}$$

In certain embodiments, some or all of the above calculations may be performed for each combination of three microseismic events within a group of microseismic events to determine the set of all potential fracture planes supported by the microseismic events. Generally, N microseismic events may supports N(N−1)(N−2)/6 planes. Each determined plane can be denoted by a 5-tuple (φ, θ, w, i, j, k), where φ, θ, w are the azimuth angle, the dip angle and the weight; i, j, k are indices of associated microseismic events. The determined weights associated with each potential plane may be plotted together to provide a probability distribution. FIG. 7 is a diagram illustrating an example probability distribution for a set of determined potential fracture planes plotted in azimuth-dip space. The weight associated with each azimuth/dip combination is plotted of the z-axis, such that azimuth/dip combinations with higher weights are identified as peaks 702-710 in the probability distribution. Each peak 702-710 may have a pair of angles (φ, θ) that define an orientation direction of the associated planes, which may indicate potential dominant orientations of hydraulic fractures.

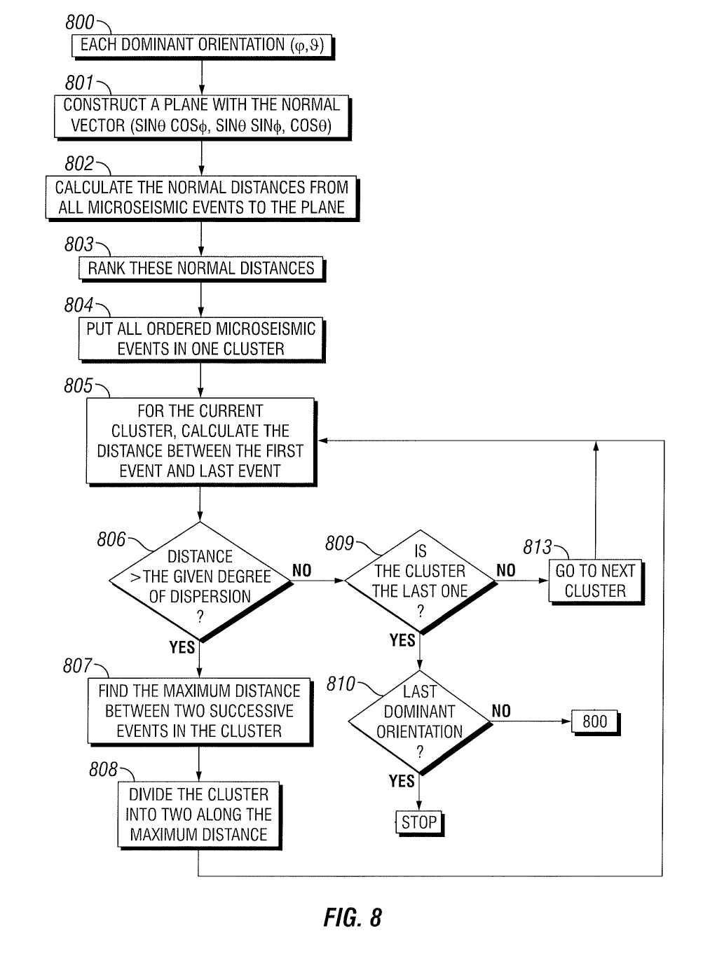

The potential dominant orientations of hydraulic fractures may be used to identify hydraulic fracture planes along the potential dominant orientations, as well as confidence values associated with each fracture plane. FIG. 8 is a diagram illustrating an example flow chart for identifying hydraulic fracture planes along the potential dominant orientations, according to aspects of the present disclosure. This flow chart may be implemented, for example, in one or more applications that may also determine the stage signatures and temporal and spatial correlations, or may be separate from one or more applications that determine those values.

Step 800 comprises selecting a first one of the potential dominant orientations with a pair of angles (φ, θ). At step 801, a plane may be constructed with a normal vector (sin θ cos φ, sin θ sin φ, cos θ). Step 802 may comprise calculating a normal distance from all microseismic events to the plane. This distance for each event may be calculated using the following equation:

distance=x sin θ cos φ+y sin θ sin φ+z cos θ

Notably, the constructed plane may be assumed to pass through the origin with respect to determining the normal distance for each microseismic event. Step 803 may comprise sorting the microseismic events based on their determined distance from the constructed plane. At step 804 the sorted or ordered list of all microseismic event may be designated as a single cluster.

After step 804, the process may begin subdividing the cluster into smaller clusters based, at least in part, on a degree of dispersion of microseisms. In certain embodiments, the degree of dispersion of microseisms may comprise the order of event-associated uncertainties or another user-defined quantity associated with geo-mechanism linking between fractures and microseisms. Step 805 may comprise determining a normal distance between the first microseismic event and the last microseismic event in the sort cluster. In certain embodiments, the following formula may be used to determine the distance between an event with coordinates (x₁, y₁, z₁) and an event with coordinates (x₂, y₂, z₂) in the direction of the normal:

d=|(x₂−x₁)sin θ cos φ+(y₂−y₁)sin θ sin φ+(z₂−z₁)cos θ|

This determined distance may comprise the width of the cluster. At step 806 the distance may be compared to the degree of dispersion of microseisms. If the distance is greater than the degree of dispersion, the distance maximum distance between subsequent microseismic events in the cluster may be identified at step 807, and the cluster divided into sub-clusters between those subsequent microseismic events at step 808. The process may then return to step 805 to determine whether the width of the sub-clusters are within the degree of dispersion or must be subdivided further. If the distance is less than the degree of dispersion, then the process may determine at step 809 is the current cluster is the last cluster. If it is not, then the process may proceed to the next cluster at step 813. Once each identified cluster and/or sub-clusters is within the degree of dispersion, the process may determine at step 810 whether the potential dominant orientation selected at step 800 is the last potential dominant orientation identified. If it is not, the process may begin again at step 800 using the next possible dominant orientation. If it is, the process may stop.

Each identified cluster and/or sub-cluster within the degree of dispersion may represent a potential actual fracture plane within the formation. For each cluster and/or sub-cluster, the parameters of the plane model ax+by+cz+d=0 described above may be numerically solved based on the locations and corresponding uncertainties of the microseismic events with the cluster and/or sub-cluster. This numerical solution may be provided using, for instance, a Chi-square fitting method. In one example embodiment, the Chi-square fitting may include minimizing the following Chi-merit function:

$${χ}^{2} ( a , b , c ) = {\sum }_{i = 1}^{K} \frac{{( {z}_{i} - {ax}_{i} - {by}_{i} - c )}^{2}}{{σ}_{i , z}^{2} + {a}^{2} {σ}_{i , x}^{2} + {b}^{2} {σ}_{i , y}^{2}}$$

where (xᵢ, yᵢ, zᵢ) represents the location of the microseismic event; (σ_{i,x}, σ_{i,y}, σ_{i,z}) represents corresponding location uncertainties that may depend, in part, on the manner in which the location was calculated or otherwise determined; and K represents the number of microseismic events within the cluster and/or sub-cluster. Minimizing this function may lead to the numerical solution of a fracture plane. The plane may be further truncated and limited based on its supporting microseismic events to represent a finite size of fracture.

Once the fracture plane numerical solutions are determined, a fracture confidence may be determined for some or all of fracture to measure their accuracy or reliability. One example fracture confidence determination can be made using the following equation based on a location uncertainties for the microseismic events within the cluster, the distances the microseismic events within the cluster and the fracture plane, the number of microseismic events associated with the plane, temporal correlations between any two supporting events, spatial correlations between two supporting events, and variation of fracture orientation:

$$Confidence = ( fracture orientation ' s weight ) \times [ {\sum }_{i = 1}^{\# events} ( location uncertainty weight ) \times ( distance variation weight ) + {\sum }_{\text{?} \leq i < j \leq \# events} ( {w}_{i}^{i , j} + {w}_{s}^{i , j} ) ] \\ \text{?} \text{indicates text missing or illegible when filed}$$

Once the fracture confidence is determined, certain of the fractures may be discarded to the extent the fracture confidence falls below a certain threshold. That threshold may be set, for instance, by a user, or it may represent an experimental- or theoretical-based value.

Once the identified fractures are determined, these fractures may be presented to one or more users. Presenting the fractures to the users may include, but is not limited to, generating a graphic in a display unit of a computing device. Based on this presentation, the user may, for instance, adjust and implement one or more parameters for subsequent stimulations operations or stages. For instance, if the fractures generated in a stimulation stage do not provide sufficient facture volumes through which hydrocarbons and other fluids may flow, the stimulation stage may be repeated to improve the fractured volume. Similarly, the parameters of the stimulation stage and formation may be correlated with the fractures to determine a relative success of the stimulation stage, and the parameters of a subsequent stimulation stage (e.g., the type of proppants or pressure) may be altered based on the determined relative success of the earlier stimulation stage.

According to aspects of the present disclosure, an example method comprises receiving data corresponding to microseismic events within a subterranean formation generated by a stimulation operation and correlating at least two microseismic events based, at least in part, on the data corresponding to the at least two microseismic events. Characteristics of at least one fracture within the formation may be determined based, at least in part, on the correlation. A subsequent stimulation operation may be performed based, at least in part, on the determined characteristics. In certain embodiments, receiving data corresponding to microseismic events within a subterranean formation generated by a stimulation operation may comprise receiving location and time data for each of the microseismic events.

In certain embodiments, correlating at least two microseismic events based, at least in part, on the data corresponding to the at least two microseismic events may comprise determining at least one of a temporal correlation weight for the at least two microseismic events using corresponding location data, and a spatial correlation weight for the at least two microseismic events using corresponding time data. In certain embodiments, determining at least one of the temporal correlation weight and the spatial correlation weight may comprise determining at least one of a distance and a time difference between the at least two microseismic events; and determining at least one of the temporal correlation weight and the spatial correlation weight using a piecewise continuous function and at least one of the determined distance and time difference between the at least two microseismic events. In certain embodiments, receiving data corresponding to microseismic events within the subterranean formation generated by the stimulation operation comprises receiving data corresponding to microseismic events collected during a stimulation stage of the stimulation operation. In certain embodiments, the method may further comprise determining a stage signature for each microseismic event, wherein determining a stage signature comprises determining a boundary for a previous stimulation stage of the stimulation operation; comparing the location of each microseismic event to the determined boundary of the previous stimulation stage; and assigning a stage signature value to each microseismic event based, at least in part, on the comparison between the corresponding location of the microseismic event and the boundary of the previous stimulation stage, wherein the stage signature value identifies the probability the microseismic event was caused by the stimulation stage.

In any of the embodiments described in the preceding paragraph, determining characteristics of at least one fracture within the formation based, at least in part, on the correlation may comprise determining at least one potential dominant fracture orientation based, at least in part, on the correlation. In certain embodiments, determining at least one potential dominant fracture orientation based, at least in part, on the correlation may comprise for each combination of three microseismic events, determining a potential fracture plane; for each determined potential fracture plane, assigning a weight based, at least in part, on the temporal correlation weights between the corresponding microseismic events, the spatial correlation weights between the corresponding microseismic events, and the stage signatures for the corresponding microseismic events; and plotting the assigned weights to identify the at least one potential dominant fracture orientation. In certain embodiments, determining characteristics of at least one fracture within the formation based, at least in part, on the correlation further may comprise identifying at least one fracture planes along the at least one potential dominant fracture orientation. In certain embodiments, identifying at least one fracture plane along the at least one potential dominant fracture orientation may comprise constructing a plane with a normal vector that depends, at least in part, on an azimuth and dip angle of the at least one potential dominant fracture orientation; determining distances from each of the microseismic events to the plane; generating one or more ordered clusters of microseismic events based, at least in part, on the determined distances, wherein the one or more ordered clusters are smaller in width than a degree of dispersions for microseisms; and determining at least one fracture plane based, at least in part, on the one or more ordered clusters. The method may further comprise determining a fracture confidence for each of the at least one determined fracture planes.

According to aspects of the present disclosure, an example system may comprise an injection system and a plurality of sensors. The system may further comprise a computing system communicably coupled to the injection system and the plurality of sensors, the computing system comprising a processor and a memory device. The memory device may contain a set of instructions that, when executed by the processor, cause the processor to receive data corresponding to microseismic events collected by the plurality of sensors, correlate at least two microseismic events based, at least in part, on the data corresponding to the at least two microseismic events, and determine characteristics of at least one fracture within the formation based, at least in part, on the correlation. In certain embodiments, the instructions that cause the processor to receive data corresponding to microseismic events further may cause the processor to receive location and time data for each of the microseismic events. In certain embodiments, the instructions that cause the processor to correlate at least two microseismic events based, at least in part, on the data corresponding to the at least two microseismic events further may cause the processor to determine at least one of a temporal correlation weight for the at least two microseismic events using corresponding location data, and a spatial correlation weight for the at least two microseismic events using corresponding time data. In certain embodiments, the instructions that cause the processor to determine at least one of the temporal correlation weight and the spatial correlation weight further may cause the processor to determine at least one of a distance and a time difference between the at least two microseismic events; and determine at least one of the temporal correlation weight and the spatial correlation weight using a piecewise continuous function and at least one of the determined distance and time difference between the at least two microseismic events. In certain embodiments, the instructions that cause the processor to receive data corresponding to microseismic events further may cause the processor to receive data corresponding to microseismic events collected during a stimulation stage of the stimulation operation. In certain embodiments, the instructions further may cause the processor to determine a stage signature for each microseismic event, wherein the instructions cause the processor to determine a boundary for a previous stimulation stage of the stimulation operation; compare the location of each microseismic event to the determined boundary of the previous stimulation stage; and assign a stage signature value to each microseismic event based, at least in part, on the comparison between the corresponding location of the microseismic event and the boundary of the previous stimulation stage, wherein the stage signature value identifies the probability the microseismic event was caused by the stimulation stage.

In any of the embodiments described in the preceding paragraph, the instructions that cause the processor to determine characteristics of at least one fracture within the formation based, at least in part, on the correlation further may cause the processor to determine at least one potential dominant fracture orientation based, at least in part, on the correlation. In certain embodiments, the instructions that cause the processor to determine at least one potential dominant fracture orientation based, at least in part, on the correlation further may cause the processor to for each combination of three microseismic events, determine a potential fracture plane; for each determined potential fracture plane, assign a weight based, at least in part, on the temporal correlation weights between the corresponding microseismic events, the spatial correlation weights between the corresponding microseismic events, and the stage signatures for the corresponding microseismic events; and plot the assigned weights to identify the at least one potential dominant fracture orientation. In certain embodiments, the instructions that cause the processor to determine characteristics of at least one fracture within the formation based, at least in part, on the correlation further may cause the processor to identify at least one fracture planes along the at least one potential dominant fracture orientation. In certain embodiments, the instructions that cause the processor to identify at least one fracture plane along the at least one potential dominant fracture orientation further may cause the processor to construct a plane with a normal vector that depends, at least in part, on an azimuth and dip angle of the at least one potential dominant fracture orientation; determine distances from each of the microseismic events to the plane; generate one or more ordered clusters of microseismic events based, at least in part, on the determined distances, wherein the one or more ordered clusters are smaller in width than a degree of dispersions for microseisms; and determine at least one fracture plane based, at least in part, on the one or more ordered clusters. In certain embodiments, the instructions further may cause the processor to determine a fracture confidence for each of the at least one determined fracture planes.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces. The term “gas” is used within the scope of the claims for the sake of convenience in representing the various equations. It should be appreciated that the term “gas” in the claims is used interchangeably with the term “oil” as the kerogen porosity calculation applies equally to a formation containing kerogen that produces gas, and a formation containing kerogen that produces oil.

What is claimed is:

1. A method, comprising:
receiving data corresponding to microseismic events within a subterranean formation generated by a stimulation operation;
correlating at least two microseismic events based, at least in part, on the data corresponding to the at least two microseismic events;
determining characteristics of at least one fracture within the formation based, at least in part, on the correlation; and
performing a subsequent stimulation operation based, at least in part, on the determined characteristics.

2. The method of claim 1, wherein receiving data corresponding to microseismic events within a subterranean formation generated by a stimulation operation comprises receiving location and time data for each of the microseismic events.

3. The method of claim 2, wherein correlating at least two microseismic events based, at least in part, on the data corresponding to the at least two microseismic events comprises determining at least one of a temporal correlation weight for the at least two microseismic events using corresponding location data, and a spatial correlation weight for the at least two microseismic events using corresponding time data.

4. The method of claim 3, wherein determining at least one of the temporal correlation weight and the spatial correlation weight comprises
determining at least one of a distance and a time difference between the at least two microseismic events; and
determining at least one of the temporal correlation weight and the spatial correlation weight using a piecewise continuous function and at least one of the determined distance and time difference between the at least two microseismic events.

5. The method of claim 3, wherein receiving data corresponding to microseismic events within the subterranean formation generated by the stimulation operation comprises receiving data corresponding to microseismic events collected during a stimulation stage of the stimulation operation.

6. The method of claim 4, further comprising determining a stage signature for each microseismic event, wherein determining a stage signature comprises
determining a boundary for a previous stimulation stage of the stimulation operation;
comparing the location of each microseismic event to the determined boundary of the previous stimulation stage; and
assigning a stage signature value to each microseismic event based, at least in part, on the comparison between the corresponding location of the microseismic event and the boundary of the previous stimulation stage, wherein the stage signature value identifies the probability the microseismic event was caused by the stimulation stage.

7. The method of claim 5, wherein determining characteristics of at least one fracture within the formation based, at least in part, on the correlation comprises determining at least one potential dominant fracture orientation based, at least in part, on the correlation.

8. The method of claim 7, wherein determining at least one potential dominant fracture orientation based, at least in part, on the correlation comprises
for each combination of three microseismic events, determining a potential fracture plane;
for each determined potential fracture plane, assigning a weight based, at least in part, on the temporal correlation weights between the corresponding microseismic events, the spatial correlation weights between the corresponding microseismic events, and the stage signatures for the corresponding microseismic events; and
plotting the assigned weights to identify the at least one potential dominant fracture orientation.

9. The method of claim 7, wherein determining characteristics of at least one fracture within the formation based, at least in part, on the correlation further comprises identifying at least one fracture planes along the at least one potential dominant fracture orientation.

10. The method of claim 9, wherein identifying at least one fracture plane along the at least one potential dominant fracture orientation comprises
constructing a plane with a normal vector that depends, at least in part, on an azimuth and dip angle of the at least one potential dominant fracture orientation;
determining distances from each of the microseismic events to the plane;
generating one or more ordered clusters of microseismic events based, at least in part, on the determined distances, wherein the one or more ordered clusters are smaller in width than a degree of dispersions for microseisms; and
determining at least one fracture plane based, at least in part, on the one or more ordered clusters.

11. The method of claim 10, further comprising determining a fracture confidence for each of the at least one determined fracture planes.

12. A system, comprising:
an injection system;
a plurality of sensors;
a computing system communicably coupled to the injection system and the plurality of sensors, the computing system comprising a processor and a memory device, wherein the memory device contains a set of instructions that, when executed by the processor, cause the processor to:
receive data corresponding to microseismic events collected by the plurality of sensors;
correlate at least two microseismic events based, at least in part, on the data corresponding to the at least two microseismic events; and
determine characteristics of at least one fracture within the formation based, at least in part, on the correlation.

13. The system of claim 12, wherein the instructions that cause the processor to receive data corresponding to microseismic events further cause the processor to receive location and time data for each of the microseismic events.

14. The system of claim 13, wherein the instructions that cause the processor to correlate at least two microseismic events based, at least in part, on the data corresponding to the at least two microseismic events further causes the processor to determine at least one of a temporal correlation weight for the at least two microseismic events using corresponding location data, and a spatial correlation weight for the at least two microseismic events using corresponding time data.

15. The system of claim 14, wherein the instructions that cause the processor to determine at least one of the temporal correlation weight and the spatial correlation weight further causes the processor to
determine at least one of a distance and a time difference between the at least two microseismic events; and
determine at least one of the temporal correlation weight and the spatial correlation weight using a piecewise continuous function and at least one of the determined distance and time difference between the at least two microseismic events.

16. The system of claim 14, wherein the instructions that cause the processor to receive data corresponding to microseismic events further causes the processor to receive data corresponding to microseismic events collected during a stimulation stage of the stimulation operation.

17. The system of claim 15, wherein the instructions further cause the processor to determine a stage signature for each microseismic event, wherein the instructions cause the processor to
determine a boundary for a previous stimulation stage of the stimulation operation;
compare the location of each microseismic event to the determined boundary of the previous stimulation stage; and
assign a stage signature value to each microseismic event based, at least in part, on the comparison between the corresponding location of the microseismic event and the boundary of the previous stimulation stage, wherein the stage signature value identifies the probability the microseismic event was caused by the stimulation stage.

18. The system of claim 16, wherein the instructions that cause the processor to determine characteristics of at least one fracture within the formation based, at least in part, on the correlation further cause the processor to determining at least one potential dominant fracture orientation based, at least in part, on the correlation.

19. The system of claim 18, wherein the instructions that cause the processor to determine at least one potential dominant fracture orientation based, at least in part, on the correlation further cause the processor to
for each combination of three microseismic events, determine a potential fracture plane;
for each determined potential fracture plane, assign a weight based, at least in part, on the temporal correlation weights between the corresponding microseismic events, the spatial correlation weights between the corresponding microseismic events, and the stage signatures for the corresponding microseismic events; and
plot the assigned weights to identify the at least one potential dominant fracture orientation.

20. The system of claim 18, wherein the instructions that cause the processor to determine characteristics of at least one fracture within the formation based, at least in part, on the correlation further causes the processor to identify at least one fracture planes along the at least one potential dominant fracture orientation.

21. The system of claim 20, wherein the instructions that cause the processor to identify at least one fracture plane along the at least one potential dominant fracture orientation further causes the processor to
construct a plane with a normal vector that depends, at least in part, on an azimuth and dip angle of the at least one potential dominant fracture orientation;
determine distances from each of the microseismic events to the plane;
generate one or more ordered clusters of microseismic events based, at least in part, on the determined distances, wherein the one or more ordered clusters are smaller in width than a degree of dispersions for microseisms; and
determine at least one fracture plane based, at least in part, on the one or more ordered clusters.

22. The system of claim 21, wherein the instructions further cause the processor to determine a fracture confidence for each of the at least one determined fracture planes.
